(19) United States
(12) Patent Application Publication
(10) Pub. No.: US 2023/0167002 A1
(43) Pub. Date: Jun. 1, 2023

(54) OPTICAL FIBERS AND METHOD OF MAKING THE SAME

(71) Applicant: CORNING INCORPORATED, Corning, NY (US)

(72) Inventors: Dane Alphanso Christie, Painted Post, NY (US); Richard Michael Fiacco, Corning, NY (US); Rostislav Radiyevich Khrapko, Corning, NY (US); Ming-Jun Li, Horseheads, NY (US); Craig Daniel Nie, Horseheads, NY (US)

(21) Appl. No.: 18/070,016

(22) Filed: Nov. 28, 2022

Related U.S. Application Data
(60) Provisional application No. 63/284,270, filed on Nov. 30, 2021.

(51) Int. Cl. C03B 37/012; G02B 6/02

(52) U.S. Cl. CPC C03B 37/01211; G02B 6/02395; C03B 37/0126; C03B 2201/12; C03B 2201/28; C03B 2201/31; C03B 2201/50

(57) ABSTRACT

The present invention relates to a method of forming an optical fiber precursor including: forming an alkali metal doped tube; inserting an optical fiber core rod within the alkali metal doped tube; forming a cladding jacket around the alkali metal doped tube; and diffusing an alkali metal from the alkali metal doped tube through a surface of the optical fiber core rod. The present invention further relates to an optical fiber preform having: an optical fiber core rod; an alkali metal doped tube surrounding the optical fiber core rod; and a cladding jacket surrounding the alkali metal doped tube.

### Cross Reference to Related Application

This application claims the benefit of priority under 35 U.S.C. § 119 of U.S. Provisional Application Ser. No. 63/284,270 filed on Nov. 30, 2021 the content of which is relied upon and incorporated herein by reference in its entirety.

### FIELD

The present disclosure relates generally to a method of manufacturing an optical fiber, and more particularly, to methods for producing an optical fiber doped with an alkali metal oxide.

### BACKGROUND

Attenuation is a principal limiting attribute of optical fibers. Optical fiber loss, for example, plays an important role in setting the limiting distance between optical fiber amplifiers. This is particularly important in long distance and ultra-long distance networks such as, for example, undersea applications, where such amplifiers represent a significant system cost, as well as a major factor in system reliability. Consequently, there is a tremendous amount of commercial interest in reducing attenuation to the lowest possible level.

For silica-based optical fibers used in long distance telecommunication transmission networks, attenuation losses have been reduced to the point where most of the remaining attenuation is due to intrinsic scattering within the glass material. Intrinsic scattering is a combination of losses associated with density and dopant concentration fluctuations.

One means of lowering the attenuation, is to add a modifier to the core glass. Such modifiers, if chosen appropriately, are capable of significantly reducing scattering losses in the fiber core, and therefore the attenuation of the fiber. Alkali metal oxides can serve as efficient modifiers.

Silica-based glasses containing an alkali metal oxide dopant, alone or in combination with other compounds, such as, for example, CaO, Al₂O₃ or F, have been proposed as core materials for optical fibers having intrinsic scattering losses lower than that of pure vitreous SiO₂. For both single- and multi-dopant glasses, high levels of contaminants, such as, for example, transition metals and —OH, have made it difficult to achieve the desired low attenuation. Often these contaminants are unintentionally introduced during the doping process.

One technique for incorporating an alkali metal oxide into silica glass is by diffusing an alkali metal directly into consolidated glass. However, efforts to diffuse alkali metals into silica glass have suffered from the simultaneous diffusion of impurities, including transition metals and water, resulting in losses well above the theoretical minimum. It would be desirable to develop a method of doping a silica glass optical fiber precursor with an alkali metal such that a fiber drawn therefrom would have a low optical loss.

### SUMMARY

In one embodiment, a method of forming an optical fiber precursor includes: forming an alkali metal doped tube; inserting an optical fiber core rod within the alkali metal doped tube; forming a cladding jacket around the alkali metal doped tube; and diffusing an alkali metal from the alkali metal doped tube through a surface of the optical fiber core rod.

A second embodiment of the present disclosure may include the first embodiment, wherein the optical fiber core rod comprises pure silica.

A third embodiment of the present disclosure may include the first embodiment, wherein the optical fiber core rod comprises silica doped with one of chlorine (Cl), germanium (Ge), or phosphorus (P).

A fourth embodiment of the present disclosure may include any of the first embodiment to third embodiment, wherein the optical fiber core rod comprises a cladding surrounding the optical fiber core rod.

A fifth embodiment of the present disclosure may include the fourth embodiment wherein the cladding surrounding the optical fiber core rod comprises silica doped with fluorine.

A sixth embodiment of the present disclosure may include any of the first embodiment to fifth embodiment, wherein the cladding jacket comprises pure silica.

A seventh embodiment of the present disclosure may include any of the first embodiment to fifth embodiment, wherein the cladding jacket comprises silica doped with fluorine.

A eighth embodiment of the present disclosure may include any of the first embodiment to seventh embodiment, wherein the alkali metal doped tube comprises silica doped with sodium (Na).

A ninth embodiment of the present disclosure relates to an optical fiber preform having: an optical fiber core rod; an alkali metal doped tube surrounding the optical fiber core rod; and a cladding jacket surrounding the alkali metal doped tube.

An tenth embodiment of the present disclosure may include the ninth embodiment, wherein the optical fiber core rod comprises pure silica.

A eleventh embodiment of the present disclosure may include the ninth embodiment, wherein the optical fiber core rod comprises silica doped with one of chlorine (Cl), germanium (Ge), or phosphorus (P).

A twelfth embodiment of the present disclosure may include any of the ninth embodiment to eleventh embodiment, wherein the optical fiber core rod comprises a cladding surrounding the optical fiber core rod.

A thirteenth embodiment of the present disclosure may include the twelfth embodiment, wherein the cladding surrounding the optical fiber core rod comprises silica doped with fluorine.

A fourteenth embodiment of the present disclosure may include any of the ninth embodiment to thirteenth embodiment, wherein the cladding jacket comprises pure silica.

An fifteenth embodiment of the present disclosure may include any of the ninth embodiment to thirteenth embodiment, wherein the cladding jacket comprises silica doped with fluorine.

A sixteenth embodiment of the present disclosure may include any of the ninth embodiment to fifteenth embodiment, wherein the alkali metal doped tube comprises silica doped with sodium (Na).

A seventeenth embodiment of the present disclosure relates to an optical fiber preform having: an optical fiber core rod; wherein the optical fiber core rod comprises a cladding surrounding the optical fiber core rod, and wherein the cladding surrounding the optical fiber core rod comprises silica doped with fluorine;

an alkali metal doped tube surrounding the optical fiber core rod; and a cladding jacket surrounding the alkali metal doped tube.

An eighteenth embodiment of the present disclosure may include the seventeenth embodiment, wherein the optical fiber core rod comprises pure silica.

A nineteenth embodiment of the present disclosure may include the seventeenth embodiment, wherein the optical fiber core rod comprises silica doped with one of chlorine (Cl), germanium (Ge), or phosphorus (P).

A twentieth embodiment of the present disclosure may include any of the seventeenth embodiment to nineteenth embodiment, wherein the alkali metal doped tube comprises silica doped with sodium (Na).

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating the exemplary embodiments.

FIG. 1 depicts an arrangement to diffuse an alkali into a silica glass tube showing the relationship between burner and alkali metal source compound locations.

FIG. 2 depicts an exemplary optical fiber preform.

FIG. 3 shows the calculated attenuation decrease as a function of the radial location of the tube.

### DETAILED DESCRIPTION

The present invention relates to a process of manufacturing a low loss optical fiber. More specifically, the invention relates to preparing an optical fiber precursor by diffusing an alkali metal into a silica glass article. Optical fiber precursor refers to a complete optical fiber preform, or a precursor to a complete optical fiber preform such as, for example, a core cane or a deposition tube. Core cane refers to a consolidated glass precursor to an optical fiber preform that is not a complete optical fiber preform but which includes at least a portion of the core. Optical fiber preform refers to a consolidated glass article ready for drawing into an optical fiber.

Silica glass doped with an alkali metal oxide has been shown capable of producing losses below the theoretical lower limit for pure silica glass. “Doped” or “doping”, or the equivalent, refers to the intentional addition of a material or materials to a glass to achieve desired characteristics (as indicated herein) in such a glass. One means of producing a low loss optical fiber is by diffusing an alkali metal into a suitable silica glass article that is a precursor to an optical fiber.

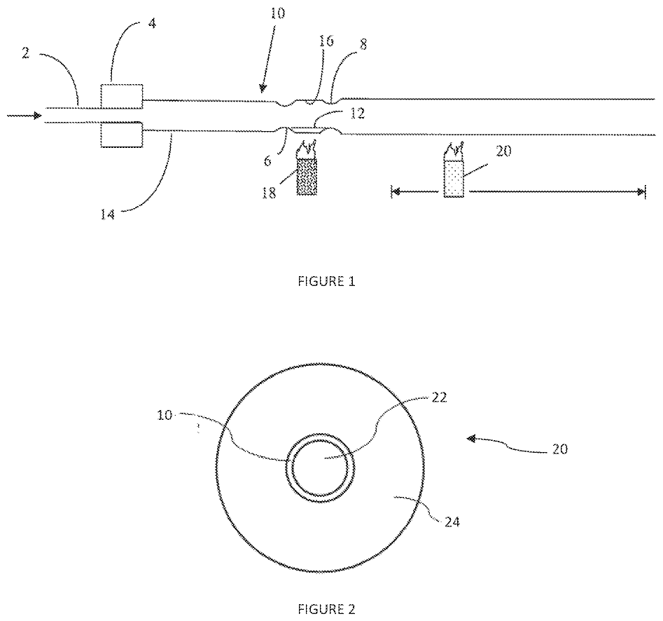

In embodiments, an illustration of which is provided in FIG. 1, a silica glass tube 10 suitable for the manufacture of optical fiber is mounted in a glass-working lathe. One example of an appropriate apparatus is a conventional modified chemical vapor deposition (MCVD) glass-forming lathe. A reservoir 16 for receiving an alkali metal source is formed near one end of tube 10 by forging two neck-like deformations, 6 and 8, in the wall of tube 10 about 2 cm from each other. The exact composition of tube 10 is dependent upon the design of the desired optical fiber, however generally such tubes contain as much as, or more than about 80 mole percent silicon dioxide (SiO₂). For the manufacture of many optical fibers tube 10 preferably contains at least about 90 mole percent SiO₂. Such tubes may also contain dopants, either singly or in combination. Such dopants may include, for example, fluorine (F), aluminum oxide (Al₂O₃), calcium oxide (CaO), germanium dioxide (GeO₂) or phosphorus (P). Prior to diffusing an alkali metal into tube 10, additional silica glass may be added to the interior surface of glass tube 10 through chemical vapor deposition means. Such additional glass may contain dopants, including, for example, F, Al₂O₃, CaO, GeO₂ or P. In embodiments, tube 10, and any additional glass deposited on the inside of tube 10, is essentially chlorine free. Essentially chlorine free refers to exhibiting a chlorine content sufficiently low that optical losses due to alkali chloride crystallization is avoided, for example a chlorine content preferably less than about 500 ppm is desired for this purpose. More preferably, the chlorine content is less than about 100 ppm, and most preferably less than about 50 ppm. In addition, silica glass tube 10, and any additional glass deposited therein, should be essentially free of “water”, referring to the hydroxyl group ^{—}OH. Water is responsible for an absorption peak at or about 1383 nm, and which absorption peak can extend into the operating wavelength regions of an optical fiber. This peak has a detrimental effect on the fiber attenuation. Therefore, it is desirable to reduce the absorption peak, also referred to as the water peak, by reducing the ^{—}OH content of the glass as much as possible. This requires that the starting materials be essentially free of water. Essentially free of water refers to having an ^{—}OH content preferably less than about 100 ppb, and more preferably less than about 20 ppb. This can be accomplished, for example, by conventional chlorine drying techniques during manufacture of the silica glass tube and employing suitable precautions subsequent to its manufacture to prevent rewetting of the tube. The use of chlorine, however, should be minimized to reduce chlorine concentrations in the glass. In the case of porous soot glass articles, drying is preferably accomplished by exposing the article to a fluorine-containing atmosphere, such as, for example, carbon tetrafluoride (CF₄) or silicon tetrafluoride (SiF₄), or combinations thereof, either after chlorine drying or in place of it. The exposure to a fluorine-containing atmosphere is done at temperatures preferably less than about 1100° C. to avoid doping the glass with high levels of fluorine. Preferably, the water content of the glass is less than about 100 ppb, and more preferably less than about 20 ppb.

Once the silica glass tube 10 has been prepared, including any deposition of additional glass, an alkali source compound 12 is introduced into tube 10 at reservoir 16 and heated by heat source 18 to form a vapor as tube 10 is rotated. Alkali metal source compound 12 may be introduced into reservoir 16 as a liquid or as a solid. Oxygen is flowed into inlet 2 and into tube 10 through rotating seal 4, and the portion of tube 10 downstream of alkali metal source compound 12 is heated to facilitate diffusion of the alkali metal into the interior surface of tube 10. The portion of tube 10 downstream of alkali metal source compound 12 should be heated to a temperature sufficient to promote rapid diffusion of the alkali and to prevent devitrification. Preferably, the portion of tube 10 downstream of alkali metal source compound 12 is heated by heat source 20 to at least about 1500° C., more preferably at least about 1700° C., and most preferably at least about 2000° C. Alkali metal source compound 12 is a non-chlorine-containing compound having as a constituent an element selected from the group consisting of potassium (K), sodium (Na), lithium (Li), cesium (Cs), and rubidium (Rb). Preferably alkali metal source compound 12 is a bromide, an iodide, or a fluoride. More preferably alkali metal source compound 12 is a bromide, an iodide or a fluoride of K or Na.

The diffusion process may be followed by the step of further heating doped tube 10 to promote a partial collapse of doped tube 10 to both reduce the inside surface area through which the alkali metal might be lost and to thicken the layer of glass into which the alkali metal has been diffused. The doped tube 10 is cut to remove that portion of glass containing reservoir 16. An optical fiber core rod (i.e. a core cane) is inserted within doped tube 10. In embodiments, the optical fiber core rod is pure silica. In embodiments, the optical fiber core rod is silica doped with one of chlorine (Cl), germanium (Ge), or phosphorus (P). In embodiments, the optical fiber core rod contains a cladding surrounding the optical fiber core rod. In embodiments, the cladding is doped with fluorine. After inserting the optical fiber core rod within the tube, a cladding jacket (e.g. a protective covering) is formed around the tube 10 and collapsed to form an optical fiber preform. In embodiments, the cladding jacket is pure silica. In embodiments, the cladding jacket is silica doped with fluorine. FIG. 2 depicts an example of an optical fiber preform 20 as described herein, having an optical fiber core rod 22 surrounded by tube 10. The tube 10 is surrounded by cladding jacket 24.

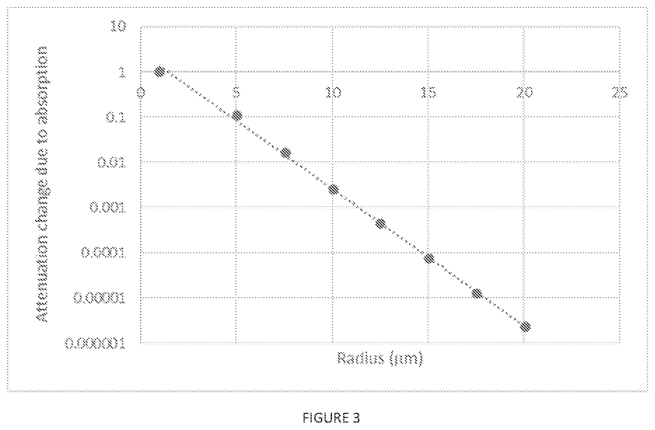

One advantage of the proposed process as described herein is that the attenuation due to contaminants in the alkali doped glass tube is greatly reduced. FIG. 3 shows the calculated attenuation decrease as a function of the radial location of the tube. Attenuation due to contaminants decreases exponentially with the radial location. For example, for the radial location of 5 μm, the attenuation is reduced to 10%, and for the radial location of 10 μm, the attenuation is reduced to below 1%.

While exemplary embodiments have been disclosed herein, it will be understood by those skilled in the art that various changes in form and details may be made therein without departing from the scope of the invention encompassed by the appended claims.

What is claimed is:

1. A method of forming an optical fiber precursor comprising:
forming an alkali metal doped tube;
inserting an optical fiber core rod within the alkali metal doped tube;
forming a cladding jacket around the alkali metal doped tube; and
diffusing an alkali metal from the alkali metal doped tube through a surface of the optical fiber core rod.

2. The method of claim 1, wherein the optical fiber core rod comprises pure silica.

3. The method of claim 1, wherein the optical fiber core rod comprises silica doped with one of chlorine (Cl), germanium (Ge), or phosphorus (P).

4. The method of claim 1, wherein the optical fiber core rod comprises a cladding surrounding the optical fiber core rod.

5. The method of claim 4, wherein the cladding surrounding the optical fiber core rod comprises silica doped with fluorine.

6. The method of claim 1, wherein the cladding jacket comprises pure silica.

7. The method of claim 1, wherein the cladding jacket comprises silica doped with fluorine.

8. The method of claim 1, wherein the alkali metal doped tube comprises silica doped with sodium (Na).

9. An optical fiber preform, comprising:
an optical fiber core rod;
an alkali metal doped tube surrounding the optical fiber core rod; and
a cladding jacket surrounding the alkali metal doped tube.

10. The optical fiber preform of claim 9, wherein the optical fiber core rod comprises pure silica.

11. The optical fiber preform of claim 9, wherein the optical fiber core rod comprises silica doped with one of chlorine (Cl), germanium (Ge), or phosphorus (P).

12. The optical fiber preform of claim 9, wherein the optical fiber core rod comprises a cladding surrounding the optical fiber core rod.

13. The optical fiber preform of claim 12, wherein the cladding surrounding the optical fiber core rod comprises silica doped with fluorine.

14. The optical fiber preform of claim 9, wherein the cladding jacket comprises pure silica.

15. The optical fiber preform of claim 9, wherein the cladding jacket comprises silica doped with fluorine.

16. The optical fiber preform of claim 9, wherein the alkali metal doped tube comprises silica doped with sodium (Na).

17. An optical fiber preform, comprising:
an optical fiber core rod; wherein the optical fiber core rod comprises a cladding surrounding the optical fiber core rod, and wherein the cladding surrounding the optical fiber core rod comprises silica doped with fluorine;
an alkali metal doped tube surrounding the optical fiber core rod; and
a cladding jacket surrounding the alkali metal doped tube.

18. The optical fiber preform of claim 17, wherein the optical fiber core rod comprises pure silica.

19. The optical fiber preform of claim 17, wherein the optical fiber core rod comprises silica doped with one of chlorine (Cl), germanium (Ge), or phosphorus (P).

20. The optical fiber preform of claim 17, wherein the alkali metal doped tube comprises silica doped with sodium (Na).
